(19) United States
(12) Patent Application Publication
(10) Pub. No.: US 2025/0310425 A1
(43) Pub. Date: Oct. 2, 2025

(54) SIGNAL TRANSFER APPARATUS, COMMUNICATION SYSTEM AND SIGNALTRANSFER METHOD

(71) Applicant: NIPPON TELEGRAPH AND TELEPHONE CORPORATION, Tokyo (JP)

(72) Inventors: Takahiro SUZUKI, Musashino-shi, Tokyo (JP); Sang-Yuep KIM, Musashino-shi, Tokyo (JP); Junichi KANI, Musashino-shi, Tokyo (JP)

(73) Assignee: NIPPON TELEGRAPH AND TELEPHONE CORPORATION, Tokyo (JP)

(21) Appl. No.: 18/863,193

(22) PCT Filed: May 25, 2022
(86) PCT No.: PCT/JP2022/021355

§ 371 Date: Nov. 5, 2024

(51) Int. Cl. H04L 69/08; H04L 69/168

(52) U.S. Cl. CPC H04L 69/08; H04L 69/168

(57) ABSTRACT

A signal transfer device includes an optical interface unit, first and second interface units, and first and second conversion units. The optical interface unit performs processing of converting a received optical signal into an electric signal to generate a reception signal, and performs processing of converting a transmission signal from an electric signal to an optical signal to transmit the converted optical signal. The first conversion unit converts the reception signal generated by the optical interface unit into a signal of a first protocol, and transmits the signal from the first interface unit. The second conversion unit converts a signal of a second protocol received by the second interface unit into a transmission signal to be transmitted by an optical signal, and outputs the converted transmission signal to the optical interface unit. Each of the first and second interface units is attachable to and detachable from the signal transfer device. The first and second conversion units are realized by a processor executing a program.

### TECHNICAL FIELD

The present invention relates to a signal transfer device, a communication system, and a signal transfer method.

### BACKGROUND ART

It is considered to realize an optical communication service using an arbitrary protocol and an edge computing service utilizing resources of an exchange station and a data center, which are not bound by protocols of a PON (Passive Optical Network) or Ethernet (registered trademark) generally used in existing access systems. In this case, a method of generating an arbitrary protocol by electric processing and then converting the protocol into light by a media converter and transferring the light is considered (see, for example, NPL 1).

FIG. 12 is a diagram showing a conventional communication system. The communication system shown in FIG. 12 provides game services using edge computing. A game controller 911 on a user side corresponds to a protocol E. The protocol E is, for example, Ethernet (registered trademark). A media converter 912 converts an electric signal of the protocol E outputted from the game controller 911 into an optical signal and transmits the optical signal to the exchange station/data center side. When the protocol E is Ethernet (registered trademark), the electric signal of the protocol E is an electric Ethernet (registered trademark) signal and the optical signal of the protocol E is an optical Ethernet (registered trademark) signal.

A general-purpose server 913 on the exchange station/data center side receives the optical signal by an optical NIC (Network Interface Card). The general-purpose server 913 generates game video on the basis of information on an operation of the game controller 911 obtained from the received optical signal. The general-purpose server 913 outputs an electric signal of a protocol H for transmitting the generated game video. For example, the protocol H is an HDMI (High-Definition Multimedia Interface) (registered trademark), and the electric signal is an electric HDMI (registered trademark) signal. A media converter 914 on the exchange station/data center side converts the electric HDMI (registered trademark) signal outputted by an HDMI (registered trademark) IF (interface) of the general-purpose server 913 into an optical HDMI (registered trademark) signal and transmits the signal to a user side. The optical HDMI (registered trademark) signal is an optical signal of protocol H. A media converter 915 on the user side receives the optical HDMI (registered trademark) signal from the exchange station/data center side, and converts the received optical HDMI (registered trademark) signal into the electric HDMI (registered trademark) signal which is an electric signal of protocol H. A monitor 916 corresponds to an electric HDMI (registered trademark). The monitor 916 displays video on the basis of the electric HDMI (registered trademark) signal received from the media converter 915.

FIG. 13 is a diagram showing another conventional communication system. The communication system shown in FIG. 13 provides industrial equipment control services using edge computing. A service for controlling industrial equipment 921 from the exchange station/data center side is assumed. The industrial equipment 921 corresponds to an industrial protocol. A media converter 922 is installed on the user side, and a media converter 923 is installed on the exchange station/data center side. The media converters 922 and 923 convert protocol signals for electric industry and protocol signals for optical industry. The industrial equipment 921 on the user side and the PLC (Programmable Logic Controller) 924 on the exchange station/data center side are optically connected by using these media converters 922 and 923.

Note that, in the two services described above, not only a configuration using the media converters but also a configuration using the PON can be assumed. In the case of a configuration using the PON, an OLT (Optical Line Terminal) and an ONU (Optical Network Unit) corresponding to each protocol are used. Then, the user is connected to the PON in a Point-to-Multi points configuration.

### CITATION LIST

### Non Patent Literature

[NPL 1] T. Toma, T. Sugeta, A. Inoue, and Y. Koike, “Development of WDM optical transmission system over GI-POF pair cable for television RF, gigabit-ethernet, and HDMI/DVI”, Paper presented at 23rd International Conference on Plastic Optical Fibers, ICPOF 2014, pp. 130-134.

### SUMMARY OF INVENTION

### Technical Problem

In the system described above, a dedicated media converter and a dedicated system are required in accordance with a protocol used by a service. Therefore, in addition to a large initial investment, a long development period is required until introduction. In addition, since it is required to manage various media converters and dedicated system such as PLC (Programmable Logic Controller) in the exchange station, an operation of a person for management increases.

In view of the above circumstances, an object of the present invention is to provide a signal transfer device, a communication system, and a signal transfer method that can relay communication of an arbitrary protocol to an optical network while reducing a load on development and resources for management.

### Solution to Problem

A signal transfer device according to an aspect of the present invention includes an optical interface unit that performs processing of receiving an optical signal, and converting the received optical signal into an electric signal to generate a reception signal, and performs processing of converting a transmission signal from an electric signal to an optical signal, and transmitting the converted optical signal, a first interface unit that transmits a signal of a first protocol, a second interface unit that receives a signal of a second protocol, a first conversion unit that converts the reception signal generated by the optical interface unit into the signal of the first protocol and transmit the signal from the first interface unit, and a second conversion unit that converts the signal of the second protocol received by the second interface unit into the transmission signal to be transmitted by an optical signal and output the converted transmission signal to the optical interface unit, wherein the first interface unit and the second interface unit are attachable and detachable respectively, and the first conversion unit and the second conversion unit are realized by a processor executing a program.

A communication system according to an aspect of the present invention includes a signal transfer device and a communication device, wherein the signal transfer device includes a first optical interface unit that performs processing of receiving a first optical signal from the communication device, and converting the received first optical signal from an optical signal to an electric signal to generate a first reception signal, and performs processing of converting a first transmission signal from an electric signal to an optical signal to generate a second optical signal, and transmitting the generated second optical signal to the communication device, a first interface unit that transmits a signal of a first protocol, a second interface unit that receives a signal of a second protocol, a first conversion unit that converts the first reception signal generated by the first optical interface unit into the signal of the first protocol, and transmits the signal from the first interface unit, and a second conversion unit that converts the signal of the second protocol received by the second interface unit into the first transmission signal to be transmitted by an optical signal and outputs the converted first transmission signal to the first optical interface unit, and the communication device includes a second optical interface unit that performs processing of converting a second transmission signal from an electric signal to an optical signal to generate the first optical signal, and transmitting the generated first optical signal to the signal transfer device, and performs processing of receiving the second optical signal from the signal transfer device, and converting the received second optical signal from an optical signal to an electric signal to generate a second reception signal, a signal generation unit that generates a signal of the first protocol, converts the generated signal of the first protocol into the second transmission signal to be transmitted by an optical signal, and outputs the converted second transmission signal to the second optical interface unit, and a reception unit that converts the second reception signal generated by the second optical interface unit into a signal of the second protocol and performs reception processing of the converted signal, wherein the first interface unit and the second interface unit are attachable to and detachable from the signal transfer device, the first conversion unit and the second conversion unit are realized by a processor of the signal transfer device executing a program, and the signal generation unit and the reception unit are realized by a processor of the communication device executing a program.

A signal transfer method according to an aspect of the present invention includes an optical reception step of receiving an optical signal and converting the received optical signal into an electric signal to generate a reception signal by an optical interface unit, a first conversion step of converting the reception signal generated in the optical reception step into a signal of a first protocol by a first conversion unit, a transmission step of transmitting the signal of the first protocol converted in the first conversion step by a first interface unit that is attachable and detachable, a reception step of receiving a signal of a second protocol by a second interface unit that is attachable and detachable; a second conversion step of converting the signal of the second protocol received in the reception step into a transmission signal to be transmitted by an optical signal interface by a second conversion unit, and an optical transmission step of converting the transmission signal converted in the second conversion step from an electric signal to an optical signal and transmitting the converted optical signal by the optical interface unit, wherein the first conversion step and the second conversion step are performed by a processor executing a program.

### Advantageous Effects of Invention

According to the present invention, communication of an arbitrary protocol can be relayed to an optical network while reducing a load on development and resources for management.

### BRIEF DESCRIPTION OF DRAWINGS

FIG. 1 is a diagram showing a configuration of a communication system according to a first embodiment of the present invention.

FIG. 2 is a diagram showing a configuration of a communication system according to the first embodiment.

FIG. 3 is a diagram showing a network configuration example according to the first embodiment.

FIG. 4 is a diagram showing a network configuration example according to the first embodiment.

FIG. 5 is a diagram showing an example of a communication system according to the first embodiment.

FIG. 6 is a diagram showing an example of a communication system according to the first embodiment.

FIG. 7 is a diagram showing an example of a communication system according to the first embodiment.

FIG. 8 is a diagram showing an example of a communication system according to the first embodiment.

FIG. 9 is a diagram showing a configuration of a communication system according to a second embodiment.

FIG. 10 is a diagram showing a sequence of the communication system according to the second embodiment.

FIG. 11 is a diagram showing a hardware configuration of a general-purpose server according to the first and the second embodiments.

FIG. 12 is a diagram showing a communication system in the related art.

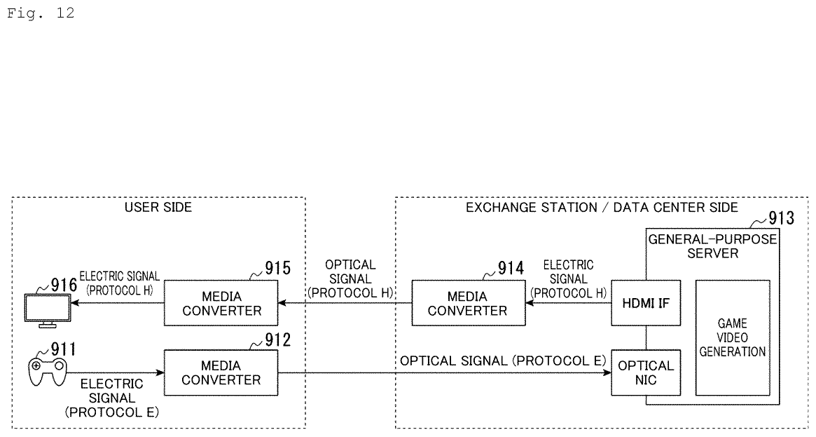

FIG. 13 is a diagram showing the communication system in the related art.

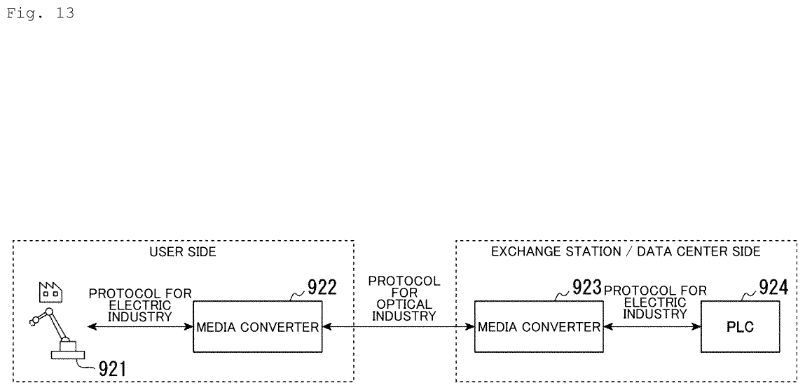

### DESCRIPTION OF EMBODIMENTS

Hereinafter, embodiments of the present invention will be described in detail with reference to drawings. Note that the same constituent elements in a plurality of drawings will be denoted by the same reference and description thereof will be omitted.

### First Embodiment

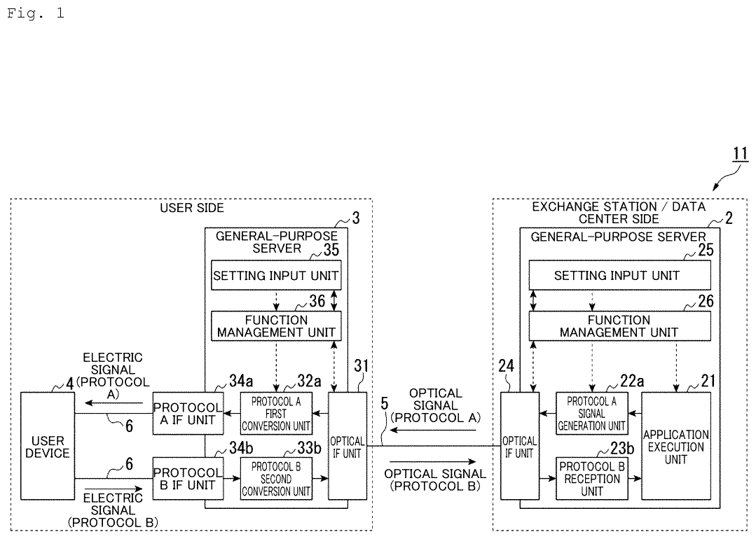

FIG. 1 is a diagram showing a configuration example of a communication system 11 according to a first embodiment of the present invention. The communication system 11 has a general-purpose server 2 on an exchange station/data center side, a general-purpose server 3 on a user side, and a user device 4. The general-purpose server 3 is an example of a signal transfer device. The general-purpose server 2 and the general-purpose server 3 are connected by an optical transmission line 5. In FIG. 1, the same optical transmission line 5 is used for an up direction and a down direction, but different optical transmission lines 5 may be used. The up direction is a direction from the general-purpose server 3 to the general-purpose server 2, and the down direction is a direction from the general-purpose server 2 to the general-purpose server 3. The general-purpose server 3 and the user device 4 are connected by a transmission line 6. Hereinafter, an electric signal of protocol X is also described as an electric protocol X signal, and an optical signal in which a signal of protocol X is set is also described as an optical protocol X signal (X=A, B, . . . ).

The user device 4 has an electric IF (interface) of one or more protocols and does not have an optical IF. In this case, the user device 4 receives the electric protocol A signal and transmits the electric protocol B signal. The protocol A and the protocol B may be the same protocol or different protocols. In addition, the user device 4 receiving the electric protocol A signal and the user device transmitting the electric protocol B signal may be different from each other.

The general-purpose server 2 includes an application execution unit 21, a signal generation unit 22, a reception unit 23, an optical IF unit 24, a setting input unit 25, and a function management unit 26. Functions of the application execution unit 21, the signal generation unit 22, the reception unit 23, the setting input unit 25, and the function management unit 26 are realized by a processor of the general-purpose server 2 reading a program from a storage medium such as a memory and executing the program.

The application execution unit 21 performs application for providing services using the user device 4.

The signal generation unit 22 generates an electric signal instructed from the application execution unit 21. The signal generation unit 22 encodes the generated electric signal to convert the electric signal into a transmission signal to be transmitted by IF of an optical signal. The signal generation unit 22 for generating the electric signal of the protocol X is described as a protocol X signal generation unit 22x. Here, the case where the general-purpose server 2 includes a protocol A signal generation unit 22a for generating the electric protocol A signal is explained as an example. The protocol A signal generation unit 22a outputs a transmission signal generated by encoding the electric protocol A signal to the optical IF unit 24.

The reception unit 23 performs reception processing on the signal received by the optical IF unit 24, and outputs data obtained by the reception processing to the application execution unit 21. The reception unit 23 for performing the reception processing of a signal of a protocol X is described as a protocol X reception unit 23x. Here, the case where the general-purpose server 2 includes a protocol B reception unit 23b for performing the reception processing of the signal of the protocol B is explained as an example. The protocol B reception unit 23b decodes the reception signal inputted from the optical IF unit 24. The protocol B reception unit 23b obtains an electric protocol B signal by detecting a frame of the protocol B from the decoded reception signal. The protocol B reception unit 23b acquires data transmitted by the user device 4 from the electric protocol B signal, and outputs the acquired data to the application execution unit 21.

The optical IF unit 24 transmits and receives the optical signal via the optical transmission line 5. The optical IF unit 24 converts the transmission signal generated by the signal generation unit 22 for the user device 4 from an electric signal to an optical signal and outputs the optical signal to the optical transmission line 5. In addition, the optical IF unit 24 receives the optical signal transmitted through the optical transmission line 5, and outputs the reception signal that is generated by converting the received optical signal into an electric signal to the reception unit 23.

The setting input unit 25 receives the input of setting for instructing to mount the signal generation unit 22 and the reception unit 23 corresponding to an arbitrary protocol and outputs setting information to the function management unit 26. The function management unit 26 mounts the signal generation unit 22 and the reception unit 23 instructed to be mounted in accordance with the setting information received from the setting input unit 25 on the general-purpose server 2.

The general-purpose server 3 has an optical IF unit 31, a first conversion unit 32, a second conversion unit 33, an IF unit 34, a setting input unit 35 and a function management unit 36. Functions of the first conversion unit 32, the second conversion unit 33, the setting input unit 35 and the function management unit 36 are realized by a processor of the general-purpose server 3 reading a program from a storage medium such as a memory and executing the program.

The optical IF unit 31 transmits and receives the optical signal via the optical transmission line 5. The optical IF unit 31 receives the optical signal transmitted through the optical transmission line 5, and outputs the signal generated by converting the received optical signal into an electric signal to the first conversion unit 32. In addition, the optical IF unit 31 converts the transmission signal outputted from the second conversion unit 33 from an electric signal to an optical signal, and outputs the converted optical signal to the optical transmission line 5.

The first conversion unit 32 converts an IF of the optical signal into an IF of the electric signal. The first conversion unit 32 for converting the IF of the optical signal into the IF of the electric signal of the protocol X is described as a protocol X first conversion unit 32x. Here, the general-purpose server 3 includes a protocol A first conversion unit 32a for converting the IF of the optical signal into the IF of the electric signal of the protocol A. The protocol A first conversion unit 32a decodes the reception signal inputted from the optical IF unit 31. The protocol A first conversion unit 32a detects a frame of the protocol A from the decoded reception signal to obtain an electric protocol A signal. The protocol A first conversion unit 32a outputs the acquired electric protocol A signal to the IF unit 34.

The second conversion unit 33 converts the IF of the electric signal into the IF of the optical signal. The second conversion unit 33 for converting the IF of the electric signal into the IF of the optical signal of the protocol X is described as a protocol X second conversion unit 33x. Here, the general-purpose server 3 includes a protocol B second conversion unit 33b for converting from the IF of the electric signal of the protocol B to the IF of the optical signal. The protocol B second conversion unit 33b encodes the electric protocol B signal inputted from the IF unit 34 and generates a transmission signal to be transmitted by the optical signal. The protocol B second conversion unit 33b outputs the generated transmission signal to the optical IF unit 31.

The IF unit 34 transmits and receives the electric signal to and from the user device 4. The IF unit 34 for transmitting and receiving the electric protocol X signal is described as a protocol X IF unit 34x. Here, the general-purpose server 3 includes a protocol A IF unit 34a for transmitting and receiving an electric protocol A signal and a protocol B IF unit 34b for transmitting and receiving an electric protocol B signal. The IF unit 34 is, for example, an IF card and can be attached to and detached from the general-purpose server 3.

The setting input unit 35 receives input of setting for instructing to mount the first conversion unit 32 and the second conversion unit 33 corresponding to an arbitrary protocol, and outputs setting information to the function management unit 36. The function management unit 36 mounts the first conversion unit 32 and the second conversion unit 33 instructed to be mounted on the general-purpose server 3 in accordance with the setting information received from the setting input unit 35.

As described above, the application execution unit 21 for executing the application, the signal generation unit 22 having an optical signal generation function of an arbitrary protocol, and the reception unit 23 having an optical signal reception function of an arbitrary protocol are mounted on the general-purpose server 2 on the exchange station/data center side. In addition, the first conversion unit 32 and the second conversion unit 33 having a function of converting the IF of the electric signal and the IF of the optical signal of an arbitrary protocol are mounted on the general-purpose server 3 on the user side. Further, the IF unit 34 corresponding to an arbitrary protocol is mounted on the general-purpose server 3. The IF unit 34 is attachable to and detachable from the general-purpose server 3. Therefore, the general-purpose server 3 can replace the IF unit 34 with the IF unit 34 corresponding to a protocol different from the protocol corresponding to the currently mounted IF unit 34.

For example, when adding the user device 4 for receiving the electric signal of the protocol C, the signal generation unit 22 for generating the electric signal of the protocol C is mounted on the general-purpose server 2. Further, the first conversion unit 32 for converting the IF of the optical signal into the IF of the protocol C is mounted on the general-purpose server 3, and an IF card operating as the IF unit 34 corresponding to the protocol C is inserted into the general-purpose server 3. In addition, for example, when adding the user device 4 for transmitting a signal of a protocol D, an IF card operating as the IF unit 34 corresponding to the protocol D is inserted into the general-purpose server 3, and the second conversion unit 33 for converting the IF of the electric signal of the protocol D into the IF of the optical signal is mounted on the general-purpose server 3. Further, the reception unit 23 for performing the reception processing of the signal of the protocol D is mounted on the general-purpose server 2.

The signal generation unit 22 and the reception unit 23 are mounted on the general-purpose server 2 by the function management unit 26. That is, the function management unit 26 mounts the signal generating unit 22 and the reception unit 23 indicated by the setting information received from the setting input unit 25 on the general-purpose server 2. For example, a program of the signal generating unit 22 and a program of the reception unit 23 corresponding to each protocol are stored in advance in a storage medium such as a memory of the general-purpose server 2. The function management unit 26 mounts the signal generation unit 22 by using the program of the instructed signal generation unit 22 among these programs, and mounts the reception unit 23 by using the program of the instructed reception unit 23. The function management unit 26 may read the program of the signal generation unit 22 or the reception unit 23 from another device connected to the general-purpose server 2 through a network.

Similarly to the case of the general-purpose server 2, the first conversion unit 32 and the second conversion unit 33 are mounted on the general-purpose server 3 by the function management unit 36. That is, the function management unit 36 mounts the first conversion unit 32 and the second conversion unit 33 indicated by the setting information received from the setting input unit 35 on the general-purpose server 3. For example, a program of the first conversion unit 32 and a program of the second conversion unit 33 corresponding to each protocol are stored in advance in a storage medium such as a memory of the general-purpose server 3. The function management unit 36 mounts the first conversion unit 32 by using the instructed program of the first conversion unit 32, and mounts the second conversion unit 33 by using the instructed program of the second conversion unit 33 among these programs. The function management unit 36 may read the program of the first conversion unit 32 or the program of the second conversion unit 33 from another device connected to the general-purpose server 3 through a network.

When the user device 4 performs only down direction communication, the general-purpose server 2 may not include the reception unit 23, and the general-purpose server 3 may not include the second conversion unit 33 and the IF unit 34 for receiving an up direction electric signal. When the user device 4 performs only up direction communication, the general-purpose server 2 may not include the signal generation unit 22, and the general-purpose server 3 may not include the first conversion unit 32 and the IF unit 34 for transmitting a down direction electric signal.

Subsequently, an operation of the communication system 11 when providing the services will be described. The protocol A signal generation unit 22a of the general-purpose server 2 receives an instruction of the application execution unit 21, generates an electric protocol A signal, and converts the electric protocol A signal into a transmission signal to be transmitted by the IF of the optical signal. The optical IF unit 24 transmits the optical protocol A signal generated by converting the transmission signal inputted from the protocol A signal generation unit 22a from an electric signal to an optical signal to the general-purpose server 3. The optical IF unit 31 of the general-purpose server 3 outputs a reception signal obtained by converting the received optical protocol A signal from an optical signal to an electric signal to the protocol A first conversion unit 32a. The protocol A first conversion unit 32a converts the reception signal inputted from the optical IF unit 31 into the electric protocol A signal. The protocol A IF unit 34a outputs the electric protocol A signal to the user device 4.

In addition, the user device 4 outputs the electric protocol B signal to the general-purpose server 3. The protocol B IF unit 34b of the general-purpose server 3 outputs the received electric signal to the protocol B second conversion unit 33b. The protocol B second conversion unit 33b encodes the electric protocol B signal and converts it into a transmission signal to be transmitted by the IF of the optical signal. The optical IF unit 31 transmits the optical protocol B signal generated by converting the transmission signal inputted from the protocol B second conversion unit 33b from an electric signal to an optical signal to the general-purpose server 2. The optical IF unit 24 of the general-purpose server 2 converts the received optical protocol B signal from an optical signal to an electric signal, and outputs the reception signal generated by the conversion to the protocol B reception unit 23b. The protocol B reception unit 23b converts the reception signal inputted from the optical IF unit 24 into the electric protocol B signal and outputs data acquired from the electric protocol B signal to the application execution unit 21.

According to the communication system 11, communication and edge computing services corresponding to various protocols can be easily realized by replacing software for realizing the functions of the signal generation unit 22 and the reception unit 23 of the general-purpose server 2, and software for realizing the functions of the first conversion unit 32 and the second conversion unit 33 of the general-purpose server 3, and replacing hardware components such as the IF unit 34 of an arbitrary protocol. That is, since the above-described user side configuration does not require a dedicated media converter, protocol-free can be realized. In addition, new services using an arbitrary protocol can be realized in a short period of time with less initial investment, and an increase of the number of types of hardware components is reduced, and management is facilitated.

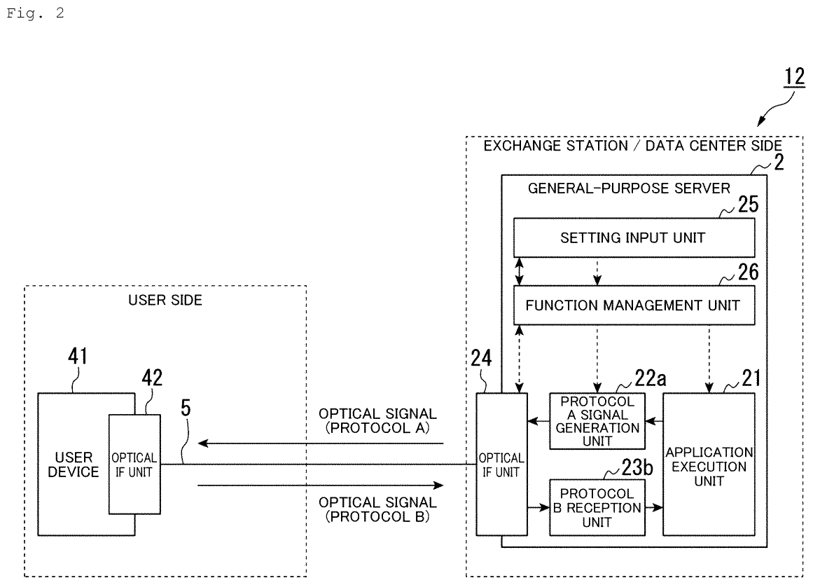

Note that the user device may have the optical IF. FIG. 2 is a diagram showing a configuration example of a communication system 12. The communication system 12 shown in FIG. 2 is different from the communication system 11 shown in FIG. 1 in that a user side has the user device 41 in place of the general-purpose server 3 and the user device 4. The general-purpose server 2 and the user device 41 are connected by the optical transmission line 5. An up direction optical transmission line 5 and a down direction optical transmission line 5 may be the same or different. The user device 41 has an optical IF unit 42. The optical IF unit 42 transmits and receives the optical signal via the optical transmission line 5. The user device 41 shown in FIG. 2 receives the optical protocol A signal by the optical IF unit 42 and transmits the optical protocol B signal.

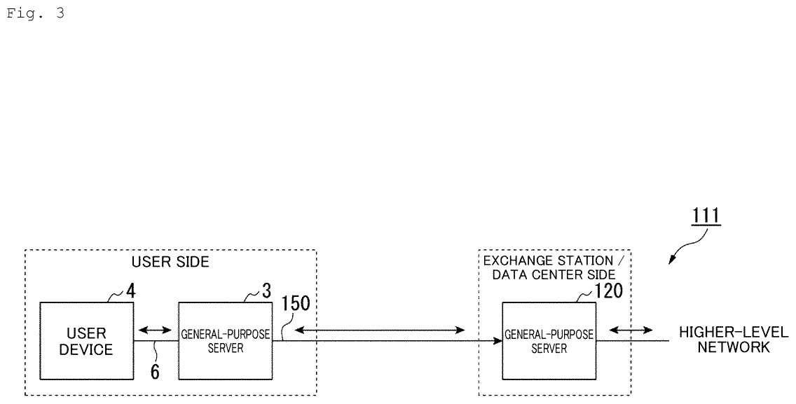

Subsequently, a configuration example of the communication system according to the present embodiment will be described. FIG. 3 is a diagram showing a network configuration example of a communication system 111. The communication system 111 has a general-purpose server 120 on the exchange station/data center side, the general-purpose server 3 on the user side, and the user device 4. The communication system 111 has a point-to-point configuration.

The general-purpose server 120 is connected to a higher-level network and the general-purpose server 3. The general-purpose server 120 corresponds to the general-purpose server 2 shown in FIG. 1. The general-purpose server 120 may not include the application execution unit 21. In this case, the general-purpose server 120 is connected to a service provision device having the application execution unit 21 via the higher-level network. The general-purpose server 120 and the general-purpose server 3 are connected by an optical transmission line 150. The optical transmission line 150 corresponds to the optical transmission line 5 shown in FIG. 1. Note that the user side may have the user device 41 shown in FIG. 2 in place of the general-purpose server 3 and the user device 4. In this case, the general-purpose server 120 is connected to the optical IF unit 42 of the user device 41 via the optical transmission line 150.

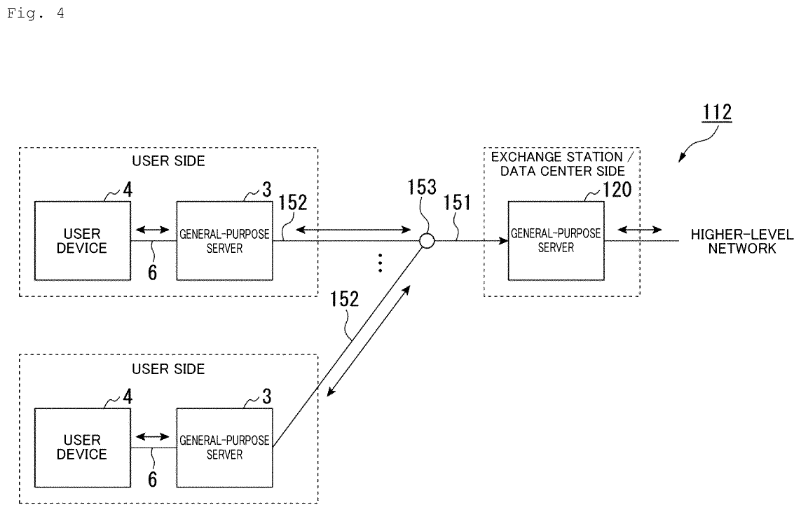

FIG. 4 is a diagram showing a network configuration example of a communication system 112. The communication system 112 has a point-to-multi points configuration. That is, the communication system 112 has the general-purpose server 120 on the exchange station/data center side, and the general-purpose server 3 and the user device 4 on each of a plurality of user sides.

The general-purpose server 120 is connected to a plurality of general-purpose servers 3 on the user side via the optical transmission line 151, an optical transmission line 152, and a branch unit 153. The optical transmission line 151, the optical transmission line 152, and the branch unit 153 correspond to the optical transmission line 5 shown in FIG. 1. The branch unit 153 is installed between the optical transmission line 151 and the plurality of optical transmission lines 152. The branch unit 153 relays the optical signal outputted from the general-purpose server 120 and transmitted through the optical transmission line 151 to any one or all of the plurality of optical transmission lines 152. The general-purpose server 3 receives the optical signal transmitted through the optical transmission line 152. In addition, the branch unit 153 multiplexes optical signals outputted from each general-purpose server 3 and transmitted through the optical transmission line 152, and outputs the optical multiplexed signal to the optical transmission line 151. Either or all of the user sides may have the user device 41 shown in FIG. 2 in place of the general-purpose server 3 and the user device 4. In this case, the optical transmission line 152 is connected to the optical IF unit 42 of the user device 41.

Subsequently, an example of performing a service for providing video generation of a game by the edge computing will be described.

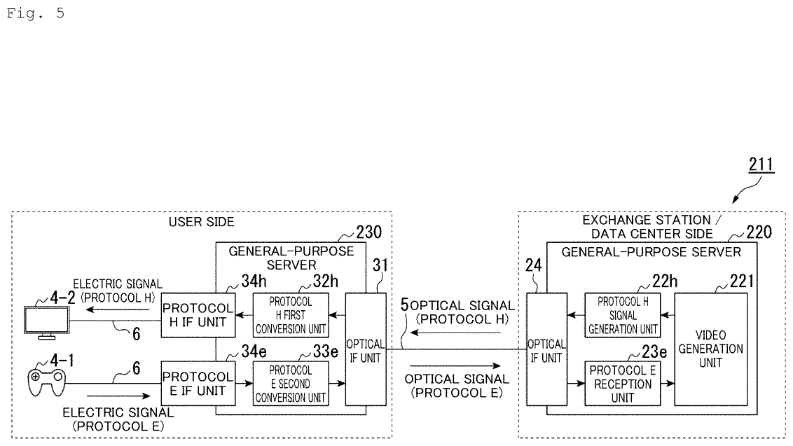

FIG. 5 is a diagram showing a configuration example of a communication system 211. The communication system 211 has a general-purpose server 220 on the exchange station/data center, a general-purpose server 230 on the user side, and two user devices 4. The general-purpose server 220 is an example of the general-purpose server 2 shown in FIG. 1. The general-purpose server 230 is an example of the general-purpose server 3 shown in FIG. 1. The general-purpose server 220 and the general-purpose server 230 are connected by the optical transmission line 5. In addition, the user side has a game controller 4-1 and a monitor 4-2 as two user devices 4. The game controller 4-1 transmits an electric signal of a protocol E, and the monitor 4-2 receives an electric signal of a protocol H. The protocol E is Ethernet (registered trademark) and protocol H is a HDMI (registered trademark) signal.

The general-purpose server 220 includes a video generation unit 221, a protocol H signal generation unit 22h, a protocol E reception unit 23e, and an optical IF unit 24. The video generation unit 221 is an example of the application execution unit 21 included in the general-purpose server 2 shown in FIG. 1. The video generation unit 221 generates video data corresponding to operation data received from the game controller 4-1 and transmits the generated video data to the monitor 4-2.

The general-purpose server 230 has an optical IF unit 31, a protocol H first conversion unit 32h, a protocol E second conversion unit 33e, a protocol H IF unit 34h, and a protocol E IF unit 34e. In FIG. 5, the setting input unit 25 and the function management unit 26 included in the general-purpose server 220, and the setting input unit 35 and the function management unit 36 included in the general-purpose server 230 are not shown. The protocol E IF unit 34e is connected to the game controller 4-1 via a transmission line 6, and the protocol H IF unit 34h is connected to the monitor 4-2 via the transmission line 6.

Operations of the communication system 211 will be described. A user performs a game operation by the game controller 4-1. The game controller 4-1 outputs an electric Ethernet (registered trademark) signal which is an electric signal of the protocol E in which data indicating a game operation performed by the user is set to the general-purpose server 230. The protocol E IF unit 34e of the general-purpose server 230 outputs the electric Ethernet (registered trademark) signal received from the game controller 4-1 to the protocol E second conversion unit 33e. The protocol E IF unit 34e converts the electric Ethernet (registered trademark) signal into a transmission signal to be transmitted by IF of the optical signal and outputs the transmission signal to the optical IF unit 31. The optical IF unit 31 converts the transmission signal received from the protocol E second conversion unit 33e from an electric signal to an optical signal to generate an optical Ethernet (registered trademark) signal which is the optical signal of the protocol E. The optical IF unit 31 transmits the generated optical signal to the general-purpose server 220.

The optical IF unit 24 of the general-purpose server 220 outputs the reception signal obtained by converting the optical Ethernet (registered trademark) signal received from the general-purpose server 230 from an optical signal to an electric signal to the protocol E reception unit 23e. The protocol E reception unit 23e converts the reception signal inputted from the optical IF unit 24 into the electric Ethernet (registered trademark) signal. The protocol E reception unit 23e outputs data obtained from the converted signal to the video generation unit 221.

The video generation unit 221 generates video data corresponding to the game operation indicated by the data received from the protocol E reception unit 23e. The video generation unit 221 of the general-purpose server 220 outputs the generated video data to the protocol H signal generation unit 22h. The protocol H signal generation unit 22h generates an electric HDMI (registered trademark) signal which is an electric signal of the protocol H in which the video data is set. The protocol H signal generation unit 22h converts the electric HDMI (registered trademark) signal into a transmission signal to be transmitted by the IF of the optical signal, and outputs the converted transmission signal to the optical IF unit 24. The optical IF unit 24 converts the transmission signal from an electric signal to an optical signal to generate an optical HDMI (registered trademark) signal which is the optical signal of the protocol H, and transmits the generated optical HDMI (registered trademark) signal to the general-purpose server 230.

The optical IF unit 31 of the general-purpose server 230 outputs a reception signal obtained by converting the received optical HDMI (registered trademark) signal from an optical signal to an electric signal. The protocol H first conversion unit 32h converts the reception signal inputted from the optical IF unit 31 into the electric HDMI (registered trademark) signal, and outputs the converted electric HDMI (registered trademark) signal to the protocol H IF unit 34h. The protocol H IF unit 34h transmits the electric HDMI (registered trademark) signal to the monitor 4-2. The monitor 4-2 displays the video data set in the electric HDMI (registered trademark) signal. The communication system 211 repeats the above-described operation.

As described above, the general-purpose server 230 on the user side is connected to the user device 4 by the electric IF, and performs conversion between the IF of the HDMI (registered trademark) and the IF of the optical signal and conversion between the IF of the Ethernet (registered trademark) and the IF of the optical signal. The IF unit 34 of the Ethernet (registered trademark) and the IF unit 34 of the HDMI (registered trademark) can be replaced with the IF unit 34 of a protocol corresponding to the user device.

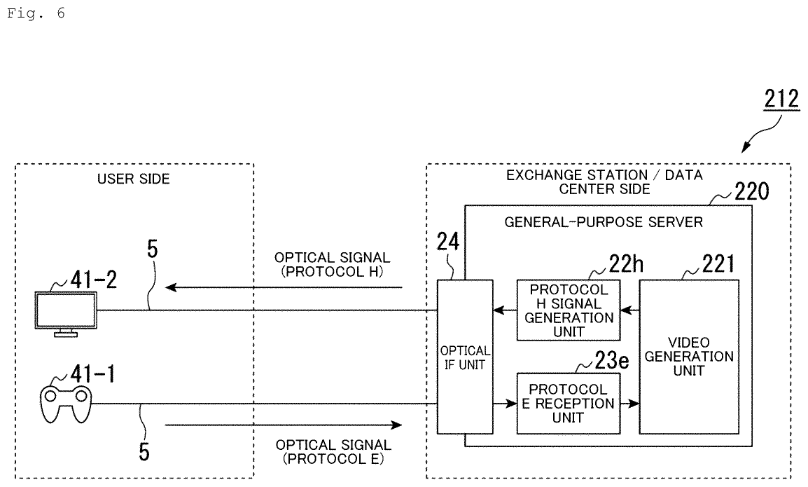

FIG. 6 shows a case where the user device has the optical IF. FIG. 6 is a diagram showing a configuration example of a communication system 212. The communication system 212 has a general-purpose server 220 on the exchange station/data center side and two user devices 41 on the user side. The user side has a game controller 41-1 and a monitor 41-2 as two user devices 41. The general-purpose server 220, the game controller 41-1 and the monitor 41-2 are respectively connected by the optical transmission line 5. The game controller 41-1 transmits the optical Ethernet (registered trademark) signal. The monitor 41-2 receives the optical HDMI (registered trademark) signal.

The user performs the game operation by the game controller 41-1. The game controller 41-1 converts the electric Ethernet (registered trademark) signal in which data indicating the game operation performed by the user is set into the optical Ethernet (registered trademark) signal, and transmits it to the general-purpose server 220. The general-purpose server 220 of the communication system 212 operates in the same manner as that of the general-purpose server 220 of the communication system 211 shown in FIG. 5. The monitor 41-2 converts the optical HDMI (registered trademark) signal from the general-purpose server 220 into the electric HDMI (registered trademark) signal, and displays the video data on the basis of the electric HDMI (registered trademark) signal.

Subsequently, an example of performing a service for providing equipment control of industrial equipment by the edge computing will be described. For example, the user connects industrial Ethernet (registered trademark) to the industrial equipment and controls the equipment.

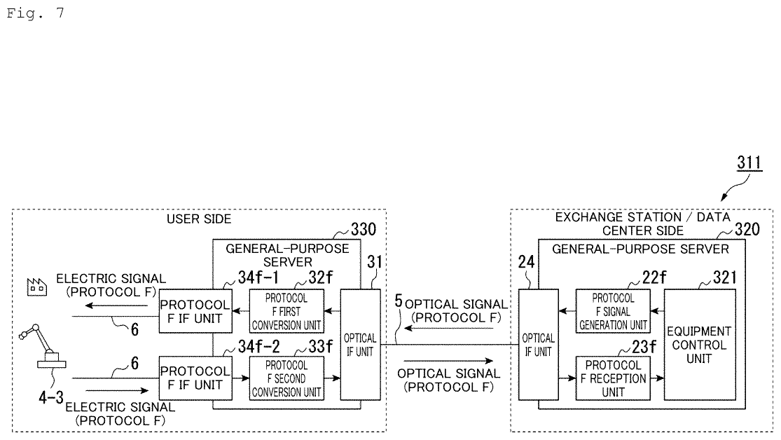

FIG. 7 is a diagram showing a configuration example of a communication system 311. The communication system 311 has a general-purpose server 320 on the exchange station/data center side, a general-purpose server 330 on the user side, and industrial equipment 4-3. The general-purpose server 320 is an example of the general-purpose server 2 shown in FIG. 1. The general-purpose server 330 is an example of the general-purpose server 3 shown in FIG. 1. The general-purpose server 320 and the general-purpose server 330 are connected by the optical transmission line 5. The industrial equipment 4-3 is an example of the user device 4. The industrial equipment 4-3 transmits and receives an electric signal of a protocol F. The protocol F is an industrial Ethernet (registered trademark).

The general-purpose server 320 includes an equipment control unit 321, a protocol F signal generation unit 22f, a protocol F reception unit 23f, and an optical IF unit 24. The equipment control unit 321 is an example of the application execution unit 21 included in the general-purpose server 2 shown in FIG. 1. The equipment control unit 321 generates a control instruction for controlling the industrial equipment 4-3 and transmits the generated control instruction to the industrial equipment 4-3. The protocol F signal generation unit 22f is a signal generation unit 22 for generating the signal of the protocol F. The protocol F reception unit 23f is a reception unit 23 for performing the reception processing of the signal of the protocol F.

The general-purpose server 330 has an optical IF unit 31, a protocol F first conversion unit 32f, a protocol F second conversion unit 33f, a protocol F IF unit 34f-1, and a protocol F IF unit 34f-2. In FIG. 6, the setting input unit 25 and the function management unit 26 included in the general-purpose server 320, and the setting input unit 35 and the function management unit 36 included in the general-purpose server 330 are not shown. The protocol F first conversion unit 32f converts a reception signal inputted from the optical IF unit 31 into an electric signal of the protocol F. The protocol F second conversion unit 33f converts the electric signal of the protocol F into a transmission signal to be transmitted by the IF of the optical signal. The protocol F IF unit 34f-1 and the protocol F IF unit 34f-2 are respectively connected to the industrial equipment 4-3 via the transmission line 6. The protocol F IF unit 34f-1 is an IF unit 34 for transmitting the electric signal of the protocol F, and the protocol F IF unit 34f-2 is an IF unit 34 for receiving the electric signal of the protocol F.

Operations of the communication system 311 will be described. The equipment control unit 321 of the general-purpose server 320 outputs an equipment control instruction to the protocol F signal generation unit 22f. The protocol F signal generation unit 22f generates an Ethernet (registered trademark) for electric industry which is an electric signal of the protocol F in which the equipment control instruction is set. The protocol F signal generation unit 22f converts the generated electric signal into a transmission signal to be transmitted by the IF of the optical signal, and outputs the converted transmission signal to the optical IF unit 24. The optical IF unit 24 converts the transmission signal from an electric signal to an optical signal to generate an Ethernet (registered trademark) signal for optical industry which is an optical signal of the protocol F. The optical IF unit 24 transmits the generated Ethernet (registered trademark) signal for optical industry to the general-purpose server 330.

The optical IF unit 31 of the general-purpose server 330 converts the received Ethernet (registered trademark) signal for the optical industry from an optical signal to an electric signal, and outputs the reception signal obtained by the conversion to the protocol F first conversion unit 32f. The protocol F first conversion unit 32f converts the reception signal inputted from the optical IF unit 31 into the Ethernet (registered trademark) signal for the electric industry, and outputs the converted Ethernet (registered trademark) signal for the electric industry to the protocol F IF unit 34f-1. The protocol F IF unit 34f-1 transmits the Ethernet (registered trademark) signal for the electric industry to the industrial equipment 4-3. The industrial equipment 4-3 operates in accordance with the equipment control instruction set in the Ethernet (registered trademark) signal for the electric industry.

The industrial equipment 4-3 outputs the Ethernet (registered trademark) signal for the electric industry in which data to be notified to the equipment control unit 321 is set to the general-purpose server 330. The protocol F IF unit 34f-2 of the general-purpose server 330 outputs the Ethernet (registered trademark) signal for the electric industry received from the industrial equipment 4-3 to the protocol F second conversion unit 33f. The protocol F second conversion unit 33f converts the Ethernet (registered trademark) signal for the electric industry into a transmission signal to be transmitted by the IF of the optical signal and outputs it to the optical IF unit 31. The optical IF unit 31 converts the transmission signal received from the protocol F second conversion unit 33f from an electric signal to an optical signal to generate an Ethernet (registered trademark) signal for the optical industry which is an optical signal of the protocol F. The optical IF unit 31 transmits an Ethernet (registered trademark) signal for optical industry to a general-purpose server 320.

The optical IF unit 24 of the general-purpose server 320 converts the optical industrial Ethernet (registered trademark) signal received from the general-purpose server 330 from an optical signal to an electric signal, and outputs the reception signal obtained by the conversion to the protocol F reception unit 23f. The protocol F reception unit 23f converts the reception signal inputted from the optical IF unit 24 into the Ethernet (registered trademark) signal for the electric industry, and outputs data obtained from the converted Ethernet (registered trademark) signal for the electric industry to the equipment control unit 321. The equipment control unit 321 generates the equipment control instruction on the basis of the data received from the protocol F reception unit 23f. The equipment control unit 321 of the general-purpose server 320 outputs the generated equipment control instruction to the protocol F signal generation unit 22f. The communication system 312 repeats the above-described operation.

As described above, the general-purpose server 330 on the user side is connected to the industrial equipment 4-3 by the electric IF, and performs the conversion between the industrial Ethernet (registered trademark) IF and the optical IF. The IF unit 34 of the industrial Ethernet (registered trademark) can be replaced with the IF unit 34 of a protocol corresponding to the user device.

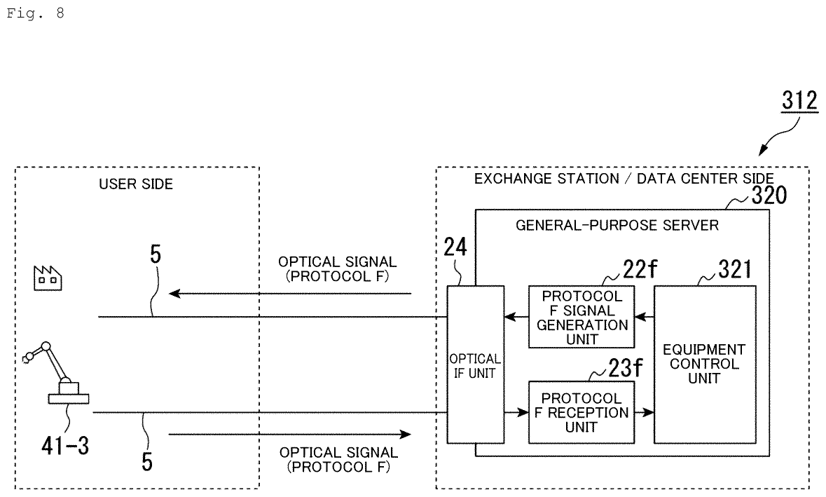

FIG. 8 shows a case where the industrial equipment has the optical IF. FIG. 8 is a diagram showing a configuration example of a communication system 312. The communication system 312 has a general-purpose server 320 on the exchange station/data center side and industrial equipment 41-3 on the user side. The industrial equipment 41-3 is an example of the user device 41 shown in FIG. 2. The general-purpose server 320 and the industrial equipment 41-3 are connected through the optical transmission line 5. The industrial equipment 41-3 transmits and receives the Ethernet (registered trademark) signal for the optical industry.

The general-purpose server 320 of the communication system 312 operates in the same manner as that of the general-purpose server 320 of the communication system 311 shown in FIG. 7. The industrial equipment 41-3 converts the Ethernet (registered trademark) signal for the optical industry from the general-purpose server 320 into the Ethernet (registered trademark) signal for the electric industry, and operates in accordance with the signal obtained by the conversion. In addition, the industrial equipment 41-3 converts the Ethernet (registered trademark) signal for the electric industry in which data to be notified to the equipment control unit 321 is set into the Ethernet (registered trademark) for the optical industry and outputs it to the general-purpose server 320.

According to the present embodiment, it is possible to relay communication of an arbitrary protocol mounted by the user device to the general-purpose server on the exchange station/data center side connected by the optical network while reducing a load on development of a dedicated device such as a media converter and resources for management.

### Second Embodiment

In the present embodiment, functions necessary for relaying communication of a user device to an optical network are activated, including a general-purpose server on the user side, by inputting the setting to the general-purpose server on the exchange station/data center side. The second embodiment will be described by focusing on a difference from the first embodiment described above.

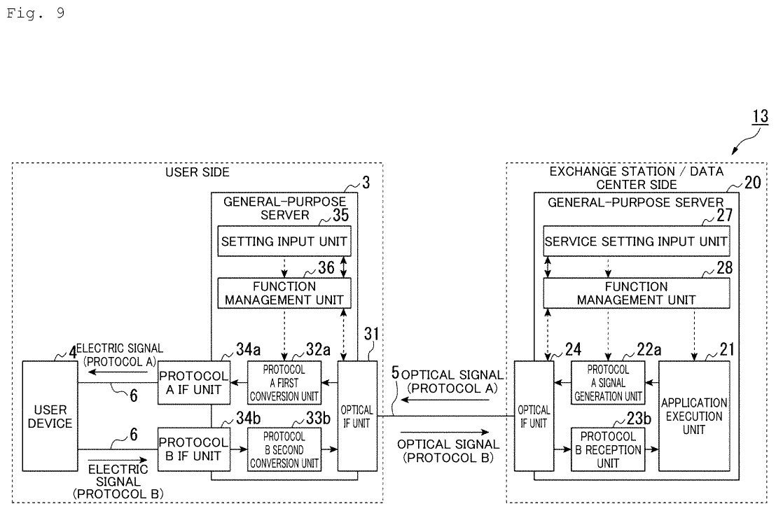

FIG. 9 is a diagram showing a configuration example of a communication system 13 according to a second embodiment. The communication system 13 shown in FIG. 3 is different from the communication system 11 shown in FIG. 1 in that a general-purpose server 20 is provided in place of the general-purpose server 2.

The general-purpose server 20 is different from the general-purpose server 2 shown in FIG. 1 in that a service setting input unit 27 and a function management unit 28 are provided in place of the setting input unit 25 and the function management unit 26. The service setting input unit 27 receives the input of service setting and outputs service setting information to the function management unit 28. The function management unit 28 selects a signal generation unit 22 and a reception unit 23 corresponding to service setting information received from the service setting input unit 27 and activates them. Further, the function management unit 28 selects a first conversion unit 32 and a second conversion unit 33 in accordance with the service setting information. The function management unit 28 transmits an activation command of the selected first conversion unit 32 and second conversion unit 33 to the general-purpose server 3. The general-purpose server 3 activates the first conversion unit 32 and the second conversion unit 33 whose activations are instructed.

For example, the function management unit 28 activates the signal generation unit 22 and the reception unit 23 selected on the basis of the service setting information among the signal generation unit 22 and the reception unit 23 corresponding to each of a plurality of protocols mounted on the general-purpose server 20 in advance. When the selected signal generation unit 22 and reception unit 23 are not mounted on the general-purpose server 20, the function management unit 28 may activate after mounting on the general-purpose server 20 by using a program of the function unit. In addition, the function management unit 28 may acquire the program from another device. Similarly, the general-purpose server 3 activates the first conversion unit 32 and the second conversion unit 33 whose activations are instructed from the function management unit 28 of the general-purpose server 20 among the first conversion unit 32 and the second conversion unit 33 corresponding to each of the plurality of protocols mounted in advance. When the first conversion unit 32 and the second conversion unit 33 whose activations are instructed are not mounted on the general-purpose server 3, the function management unit 36 may activate after mounting on the general-purpose server 3 by using a program of the function unit. The function management unit 36 of the general-purpose server 3 may acquire the program from another device.

With the above configuration, the service setting input is performed by the service setting input unit 27 of the general-purpose server 20 on the exchange station/data center. The function management unit 28 of the general-purpose server 20 activates the signal generation unit 22 and the reception unit 23 of an arbitrary protocol corresponding to the inputted service setting. The function management unit 28 may activate either the signal generation unit 22 or the reception unit 23 in accordance with the service setting. In addition, the function management unit 28 activates the first conversion unit 32 and the second conversion unit 33 for performing the conversion between the IF of the electric signal and the IF of the optical signal of an arbitrary protocol in accordance with the inputted service setting information. The function management unit 36 may activate one of the first conversion unit 32 and the second conversion unit 33 in accordance with the service setting.

Also, the service setting may be inputted to the general-purpose server 3 on the user side. In this case, the function management unit 36 performs the same processing as that of the function management unit 28 described above on the basis of the service setting inputted by the setting input unit 35, and activates the first conversion unit 32 and the second conversion unit 33 for performing the conversion between an electric signal and an optical signal of an arbitrary protocol corresponding to the service setting information. The function management unit 36 may activate one of the first conversion unit 32 and the second conversion unit 33 in accordance with the service setting.

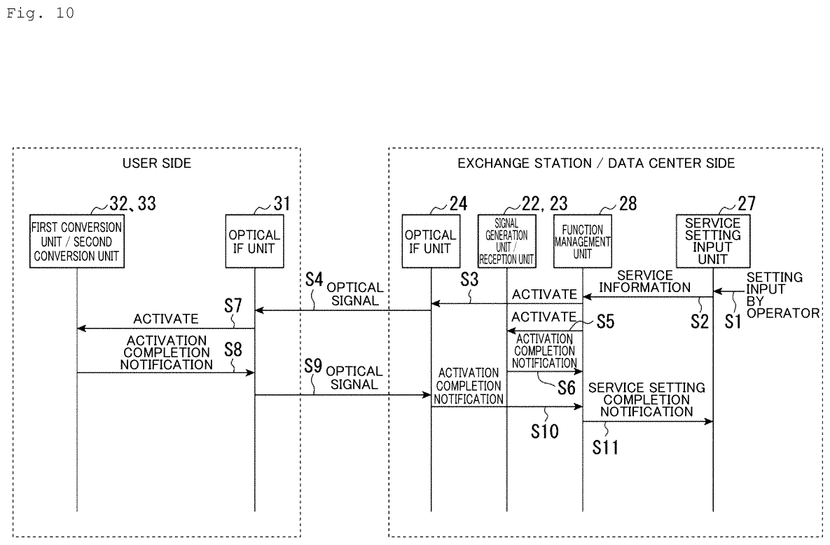

FIG. 10 is a diagram showing a function activation sequence of the communication system 13. First, an operator inputs service setting to the general-purpose server 20 (step S1). The service setting input unit 27 of the general-purpose server 20 receives information of the inputted service setting and outputs service information to the function management unit 28 (step S2). The service information is, for example, identification information (ID) for specifying which service is applied such as a service for directly transmitting the HDMI (registered trademark) signal to the user or a service for directly transmitting and receiving industrial Ethernet (registered trademark) to and from the user.

The function management unit 28 stores a table in which service information and information specifying a function unit to be activated are associated with each other in advance. The information for specifying the function unit is represented by a combination of the type of protocol and the information of function. The type of protocol represents, for example, a protocol A, a protocol B, The information of function represents one or both of the signal generation function and the reception function. A function unit to be activated is determined by the combination of the type of protocol and the signal generation function. For example, when the type of protocol is the protocol X and the function is the signal generation function, the function units to be activated are the protocol X signal generation unit 22x and the protocol X first conversion unit 32x. However, when the service information indicates the identification information of the service for directly transmitting the optical signal to the user, the protocol X first conversion unit 32x is not an activation target. In addition, when the type of protocol is the protocol X and the function is the reception function, the function units to be activated are the protocol X reception unit 23x and the protocol X second conversion unit 33x. However, when the service information indicates the identification information of the service for directly receiving the optical signal from the user, the protocol X second conversion unit 33x is not the activation target.

The function management unit 28 reads information of the function unit to be activated corresponding to the service indicated by the inputted information from the table. The function management unit 28 outputs the activation command of the function unit to be activated in the general-purpose server 3 to the optical IF unit 24 (step S3). For example, the function management unit 28 outputs the activation command of a protocol C first conversion unit 32c and the activation command of a protocol D second conversion unit 33d. The optical IF unit 24 converts the activation command into an optical signal and transmits it to the general-purpose server 3 (step S4).

The function management unit 28 outputs a function command of the function unit to be activated in the general-purpose server 20 in parallel with the processing of the step S3 (step S5). For example, the function management unit 28 outputs the activation command of a protocol C signal generation unit 22c and the activation command of a protocol D reception unit 23d. The general-purpose server 20 activates the signal generation unit 22 and the reception unit 23 receiving the activation command. When the activation is completed, the signal generation unit 22 and the reception unit 23 output an activation completion notification to the function management unit 28 (step S6).

The optical IF unit 31 of the general-purpose server 3 receives the optical signal from the general-purpose server 20, converts the activation command of the received optical signal into an electric signal, and outputs the electric signal. The general-purpose server 3 activates the first conversion unit 32 and the second conversion unit 33 receiving the activation command (step S7). When the activation is completed, the first conversion unit 32 and the second conversion unit 33 output the activation completion notification (step S8). The optical IF unit 31 converts the activation completion notification into an optical signal and transmits it to the general-purpose server 20 (step S9).

The optical IF unit 24 of the general-purpose server 20 receives the activation completion notice of the optical signal from the general-purpose server 3 and converts it into an electric signal. The optical IF unit 24 outputs the activation completion notice to the function management unit 28 (step S10). The function management unit 28 outputs a service setting completion notification to the service setting input unit 27 when receiving the activation completion notification from all the function units to which the activation commands are outputted (step S11). The service setting input unit 27 may output the service setting completion notification through a user interface such as the display. Thus, the activation of a series of arbitrary protocols is completed.

According to the communication system 13, in addition to the effect of the first embodiment, the activation and replacement of the signal generation unit 22 and the reception unit 23 of the general-purpose server 20, and the first conversion unit 32 and the second conversion unit 33 of the general-purpose server 3 can be realized in accordance with the service setting inputted to the general-purpose server 20.

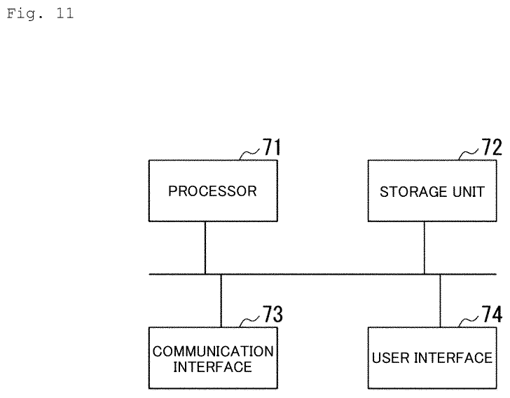

Subsequently, a hardware configuration example of the general-purpose servers 2, 20, 220, and 320 and the general-purpose servers 3, 230, and 330 will be described. FIG. 11 is a device configuration diagram showing a hardware configuration example of the general-purpose servers 2, 20, 220, and 320. The general-purpose servers 2, 20, 220, and 320 include a processor 71, a storage unit 72, a communication interface 73, and a user interface 74.

The processor 71 is a central processing device that performs an operation or control. The processor 71 is, for example, a CPU (central processing unit) or a GPU (Graphics Processing Unit). The processor 71 realizes the functions of the application execution unit 21, the signal generation unit 22, the reception unit 23, the setting input unit 25, the function management unit 26, the service setting input unit 27, and the function management unit 28 by reading a program from the storage unit 72 and executing it. The storage unit 72 further has a work area and the like used when the processor 71 executes various programs. The communication interface 73 is used to connect with other devices so as to be communicable. The communication interface 73 corresponds to the optical IF unit 24. The user interface 74 is an input device such as a keyboard, a pointing device (mouse, tablet, or the like), buttons, a touch panel and a display device such as a display. An artificial operation is inputted with the user interface 74.

The hardware configuration of the general-purpose servers 3, 230, and 330 is also the same as that in FIG. 11. The processor 71 realizes the functions of the first conversion unit 32, the second conversion unit 33, the setting input unit 35, and the function management unit 36 by reading a program from the storage unit 72 and executing it. In addition, the general-purpose servers 3, 230, and 330 have a communication interface 73 corresponding to the optical IF unit 31 and the communication interface 73 corresponding to the IF unit 34. The communication interface 73 corresponding to the IF unit 34 is an attachable and detachable interface card.

According to the embodiment described above, the communication system has a signal transfer device and a communication device. For example, the signal transfer device corresponds to the general-purpose servers 3, 230, and 330 of the embodiments, and the communication device corresponds to the general-purpose servers 2, 20, 220, and 320 of the embodiments.

The signal transfer device includes a first optical interface unit, a first interface unit, a second interface unit, a first conversion unit, and a second conversion unit. For example, the first optical interface unit corresponds to the optical IF unit 31 of the embodiments, the first interface unit and the second interface unit correspond to the IF unit 34 of the embodiments, the first conversion unit corresponds to the first conversion unit 32 of the embodiments, and the second conversion unit corresponds to the second conversion unit 33 of the embodiments. The first optical interface unit performs processing of receiving a first optical signal from the communication device, and converting the received first optical signal from an optical signal to an electric signal to generate a first reception signal, and performs processing of converting a first transmission signal from an electric signal to an optical signal to generate a second optical signal, and transmitting the generated second optical signal to the communication device. The first interface unit transmits a signal of a first protocol. The second interface unit receives a signal of a second protocol. The first conversion unit converts the first reception signal generated by the first optical interface unit into a signal of the first protocol, and transmits the signal from the first interface unit. The second conversion unit converts the signal of the second protocol received by the second interface unit into a first transmission signal to be transmitted by the optical signal, and outputs the converted first transmission signal to the first optical interface unit. The first interface unit and the second interface unit are attachable to and detachable from the signal transfer device. The first conversion unit and the second conversion unit are realized by the processor of the signal transfer device executing a program.

The communication device includes the second optical interface unit, the signal generation unit, and the reception unit. For example, the second optical interface unit corresponds to the optical IF unit 24 of the embodiments, the signal generation unit corresponds to the signal generation unit 22 of the embodiments, and the reception unit corresponds to the reception unit 23 of the embodiments. The second optical interface unit performs processing of converting the second transmission signal from an electric signal to an optical signal to generate a first optical signal, and transmitting the generated first optical signal to the signal transfer device, and performs processing of receiving the second optical signal from the signal transfer device, and converting the received second optical signal from an optical signal to an electric signal to generate a second reception signal. The signal generation unit generates a signal of the first protocol, converts the generated signal of the first protocol into a second transmission signal to be transmitted by the optical signal, and outputs the converted second transmission signal to the second optical interface unit. The reception unit converts the second reception signal generated by the second optical interface unit into a signal of the second protocol, and performs reception processing of the converted signal. The signal generation unit and the signal reception unit are realized by the processor of the communication device executing the program.

The first protocol and the second protocol may be different protocols or the same protocol.

The communication device may further include a function management unit. The function management unit corresponds to, for example, the function management unit 28 of the embodiments. The function management unit activates the first conversion unit, the second conversion unit, the signal generation unit, and the reception unit selected on the basis of inputted information among the first conversion unit, the second conversion unit, the signal generation unit, and the reception unit corresponding to each of the different protocols. The function management unit may transmit the activation command of the selected first conversion unit and second conversion unit to the signal transfer device. The signal transfer device receives the activation command and activates the first conversion unit and the second conversion unit.

As described above, although the embodiments of the present invention have been described in detail with reference to the drawings, a specific configuration is not limited to this embodiment, and design within the scope of the gist of the present invention, and the like are included.

### Reference Signs List

2 General-purpose server
3 General-purpose server
4 User device
4-1 Game controller
4-2 Monitor
4-3 Industrial equipment
5 Optical transmission line
6 Transmission line
11 Communication system
12 Communication system
13 Communication system
20 General-purpose server
21 Application execution unit
22a Protocol A signal generation unit
22f Protocol F signal generation unit
22h Protocol H signal generation unit
23b Protocol B reception unit
23e Protocol E reception unit
23f Protocol F reception unit
24 Optical IF unit
25 Setting input unit
26 Function management unit
27 Service setting input unit
28 Function management unit
31 Optical IF unit 32a Protocol A first conversion unit 32f Protocol F first conversion unit
32h Protocol H first conversion unit
33b Protocol B second conversion unit
33e Protocol E second conversion unit
33f Protocol F second conversion unit
34a Protocol A IF unit
34b Protocol B IF unit
34e Protocol E IF unit
34f-1 Protocol F IF unit
34f-2 Protocol F IF unit
34h Protocol H IF unit
35 Setting input unit
36 Function management unit
41 User device
41-1 Game controller
41-2 Monitor
41-3 Industrial equipment
42 Optical IF unit
71 Processor
72 Storage unit
73 Communication interface
74 User interface
111 Communication system
112 Communication system
120 General-purpose server
150 Optical transmission line
151 Optical transmission line
152 Optical transmission line
153 Branch unit
211 Communication system
212 Communication system
220 General-purpose server
221 Video generation unit
230 General-purpose server
311 Communication system
312 Communication system
320 General-purpose server
321 Equipment control unit
330 General-purpose server
911 Game controller
912 Media converter
913 General-purpose server
914 Media converter
915 Media converter
916 Monitor
921 Industrial equipment
922 Media converter
923 Media converter

1. A signal transfer device comprising:
an optical interface unit configured to perform processing of receiving an optical signal, and converting the received optical signal into an electric signal to generate a reception signal, and perform processing of converting a transmission signal from an electric signal to an optical signal, and transmitting the converted optical signal;
a first interface unit configured to transmit a signal of a first protocol;
a second interface unit configured to receive a signal of a second protocol;
a processor; and
a storage medium having computer program instructions stored thereon, when executed by the processor, perform to:
convert the reception signal generated by the optical interface unit into the signal of the first protocol and transmit the signal from the first interface unit; and
convert the signal of the second protocol received by the second interface unit into the transmission signal to be transmitted by an optical signal and output the converted transmission signal to the optical interface unit, wherein
the first interface unit and the second interface unit are attachable and detachable respectively.

2. The signal transfer device according to claim 1, wherein the first protocol and the second protocol are different protocols or the same protocol.

3. The signal transfer device according to claim 1, wherein
the signal transfer device activates one or both of the first conversion unit and the second conversion unit to be activated selected on the basis of information acquired by a communication device of a transmission destination or a transmission source of the optical signal.

4. A communication system comprising a signal transfer device and a communication device, wherein
the signal transfer device comprises
a first optical interface unit that performs processing of receiving a first optical signal from the communication device, and generating a first reception signal obtained by converting the received first optical signal from an optical signal to an electric signal, and performs processing of generating a second optical signal obtained by converting a first transmission signal from an electric signal to an optical signal, and transmitting the generated second optical signal to the communication device,
a first interface unit that transmits a signal of a first protocol,
a second interface unit that receives a signal of a second protocol,
a first conversion unit that converts the first reception signal generated by the first optical interface unit into the signal of the first protocol, and transmits the signal from the first interface unit, and
a second conversion unit that converts the signal of the second protocol received by the second interface unit into the first transmission signal to be transmitted by an optical signal and outputs the converted first transmission signal to the first optical interface unit, and
the communication device comprises
a second optical interface unit that performs processing of generating the first optical signal obtained by converting a second transmission signal from an electric signal to an optical signal, and transmitting the generated first optical signal to the signal transfer device, and performs processing of receiving the second optical signal from the signal transfer device, and generating a second reception signal obtained by converting the received second optical signal from an optical signal to an electric signal,
a signal generation unit that generates a signal of the first protocol, converts the generated signal of the first protocol into the second transmission signal to be transmitted by an optical signal, and outputs the converted second transmission signal to the second optical interface unit, and
a reception unit that converts the second reception signal generated by the second optical interface unit into a signal of the second protocol and performs reception processing of the converted signal, and
the first interface unit and the second interface unit are attachable to and detachable from the signal transfer device,
the first conversion unit and the second conversion unit are realized by a processor of the signal transfer device executing a program, and
the signal generation unit and the reception unit are realized by a processor of the communication device executing a program.

5. The communication system according to claim 4, wherein the communication device further comprises a function management unit that activates the first conversion unit, the second conversion unit, the signal generation unit, and the reception unit selected on the basis of inputted information among the first conversion unit, the second conversion unit, the signal generation unit, the reception unit that correspond to different protocols respectively.

6. The communication system according to claim 5, wherein the function management unit transmits an activation command of the selected first conversion unit and second conversion unit to the signal transfer device, and the signal transfer device receives the activation command and activates the first conversion unit and the second conversion unit.

7. A signal transfer method comprising:
an optical reception step of receiving an optical signal and converting the received optical signal into an electric signal to generate a reception signal by an optical interface unit;
a first conversion step of converting the reception signal generated in the optical reception step into a signal of a first protocol by a first conversion unit;
a transmission step of transmitting the signal of the first protocol converted in the first conversion step by a first interface unit that is attachable and detachable;
a reception step of receiving a signal of a second protocol by a second interface unit that is attachable and detachable;
a second conversion step of converting the signal of the second protocol received in the reception step into a transmission signal to be transmitted by an optical signal interface by a second conversion unit; and
an optical transmission step of converting the transmission signal converted in the second conversion step from an electric signal to an optical signal and transmitting the converted optical signal by the optical interface unit, wherein
the first conversion step and the second conversion step are performed by a processor executing a program.
